(19) United States
(12) Patent Application Publication
(10) Pub. No.: US 2026/0350339 A1
(43) Pub. Date: Nov. 5, 2026

(54) RADIO-FREQUENCY IDENTIFICATION (RFID) TAG AND A METHOD OF MANUFACTURING

(71) Applicant: Avery Dennison Retail Information Services LLC, Mentor, OH (US)

(72) Inventors: Peter COCKERELL, Nottinghamshire (GB); Edward J. McGINNISS, Clinton, SC (US); Christian K. OELSNER, Greensboro, NC (US); Joshua SPARROW, Greenwood, SC (US); Samantha STRANGE, Simpsonville, NC (US)

(21) Appl. No.: 19/664,295

(22) Filed: Apr. 30, 2026

Related U.S. Application Data
(60) Provisional application No. 63/798,194, filed on May 1, 2025.
(60) Provisional application No. 63/814,536, filed on May 30, 2025.

(51) Int. Cl. G06K 19/077

(52) U.S. Cl. CPC G06K 19/0776; G06K 19/07722

(57) ABSTRACT

The present disclosure provides a radio-frequency identification (RFID) tag comprising an antenna, a strap electrically connected to the antenna, and a pattern printed layer. The pattern printed layer is configured to modify adhesion characteristics in a specific area of the RFID tag. The pattern printed layer may be positioned between a liner and at least one of the antenna or the strap. The pattern printed layer comprises a plurality of discrete adhesive areas and at least a portion of the pattern printed layer may be formed in various patterns such as hexagonal patterns, dot patterns, diagonal patterns, horizontal lines, circular patterns, zigzag patterns, vertical lines, or as otherwise described herein. The pattern printed layer is configured to reduce adhesive strength in an area proximate to a connection between antenna leads and the strap, preventing delamination of the strap from the antenna, when the RFID tag is removed from the liner.

### CROSS-REFERENCE TO RELATED APPLICATIONS

The present application claims priority to U.S. Provisional Application Nos. 63/798,194 filed May 1, 2025 and 63/814,536 filed May 30, 2025, the entire contents and disclosures of each of which are hereby incorporated by reference.

### FIELD OF INVENTION

The present disclosure relates to radio-frequency identification (RFID) tags and methods of manufacturing RFID tags, and more particularly to RFID tags with pattern printed layers configured to modify adhesion characteristics in a specific area.

### BACKGROUND

Radio-frequency identification (RFID) technology has become increasingly prevalent in various industries for tracking and identifying objects. RFID systems typically consist of tags containing information and readers that can wirelessly retrieve that information. These systems offer advantages over traditional barcode technology, such as the ability to read multiple tags simultaneously without line-of-sight requirements.

In many RFID applications, tags are attached to items using adhesives. The construction of an RFID tag often involves multiple layers, including an antenna, a microchip, a strap/interposer (which serves as a bonding pad for the chip), and various adhesive layers. The integrity of these adhesive bonds may be important for maintaining the tag's functionality throughout its intended lifespan.

One challenge in RFID tag manufacturing is balancing the need for strong adhesion between components with the requirements for optimal radio frequency performance. Adhesive layers that are too thick may interfere with the tag's ability to communicate effectively with readers. Conversely, insufficient adhesion may lead to component separation, potentially rendering the tag inoperable.

The process of attaching the interposer or strap (which includes the chip) to the antenna, known as strap attach, is a particularly delicate step in RFID tag production. The electrical connection between these components should be reliable, while the mechanical bond is designed to withstand various environmental stresses and handling during application and use.

In recent years, RFID tag manufacturing has faced the "sticky strap" problem. This problem arises from the conflicting requirements of the strength of the strap adhesive layer and radio frequency (RF) performance in the attachment of the interposer or strap to the antenna. The core of the issue lies in the thickness of the strap adhesive layer. To achieve optimal RF performance, the adhesive layer must be very thin, typically 4-6 μm thick. However, this thin adhesive layer may result in weak mechanical bonding between the strap and the antenna. The weak mechanical bond may lead to a common failure mode, where the strap delaminates from the antenna when a label is removed from its liner. This delamination can render the RFID tag inoperable, causing product failures and reliability issues in real-world applications.

Traditional solutions to address the sticky strap problem include applying a thin laminate such as Electro Static Dissipative Laminate (ESD Laminate) over the strap to keep the strap from delaminating, making inlays on a carrier and inverting the inlay to sandwich the strap between the face stock and the carrier, or in many cases, using both solutions together. However, these approaches may add complexity and cost to the manufacturing process.

Another significant issue in RFID tag manufacturing is the bond pad flipping problem. This may occur during the inlay transfer process of RFID manufacturing and is a result of adhesive strength differences. Specifically, the antenna pressure-sensitive adhesive (PSA) to the liner may be stronger than the strap PSA to the antenna. During inlay transfer, a portion of the bond pad may not be cleanly transferred, causing the strap-antenna interface to sit unevenly. When a functional liner is subsequently laminated, the bond pad may flip thereby potentially compromising tag performance.

As RFID technology continues to evolve and find new applications, there is a constant drive to enhance tag reliability, reduce production costs, and improve overall system performance. Advancements in materials science, manufacturing processes, and tag design all may contribute to the ongoing refinement of RFID technology.

Accordingly, there is a long-standing need for an improved RFID tag and method of RFID tag manufacturing that can overcome the aforementioned limitations and challenges while maintaining reliable electrical performance and robust mechanical integrity.

### SUMMARY

The summary above and the following detailed description of illustrative embodiments are better understood when read in conjunction with the appended drawings. For the purpose of illustrating the present subject matter, exemplary constructions of the subject matter are shown in the drawings. However, the present subject matter is not limited to the specific methods and instrumentalities disclosed herein. Moreover, those in the art will understand that the drawings are not to scale. Wherever possible, like elements have been indicated by identical numbers.

In some embodiments, a radio-frequency identification (RFID) tag is provided. The RFID tag may include an antenna, a strap electrically connected to the antenna, and a pattern printed layer. The pattern printed layer may comprise an adhesive, a release agent, a varnish or a combination thereof. Preferably, the pattern printed layer may be a pattern printed adhesive layer. In some embodiments, the pattern printed layer may be configured to modify adhesion characteristics in a specific area of the RFID tag. In some embodiments, the specific area may be an area proximate to a connection between the antenna leads and the strap of the RFID tag. Accordingly, the pattern printed adhesive layer may be configured to reduce adhesive strength in an area proximate to a connection between the antenna leads and the strap.

In some embodiments, a method of manufacturing a radio-frequency identification (RFID) tag is provided. The method may involve electrically connecting an antenna to a strap and applying a pattern printed layer between a liner and at least one of the antenna or the strap. The pattern printed layer may be configured to modify adhesion characteristics in a specific area of the RFID tag.

In some embodiments, a method of improving adhesion in a radio-frequency identification (RFID) tag is provided. The method may include identifying areas proximate to a connection between antenna leads and a strap of the RFID tag requiring different adhesion characteristics, and selectively modifying adhesive properties in the identified areas by pattern printing an adhesive layer.

In some embodiments, a radio-frequency identification (RFID) tag laminate structure may comprise an antenna, a strap electrically connected to the antenna, a pattern printed layer, and a facestock layer disposed over the antenna and the strap. The pattern printed layer may be configured to modify adhesion characteristics in a specific area of the RFID tag laminate structure.

The foregoing general description of the illustrative embodiments and the following detailed description thereof are merely exemplary aspects of the teachings of this disclosure and are not restrictive.

### BRIEF DESCRIPTION OF DRAWINGS

Embodiments of the present subject matter will now be described, by way of example only, with reference to the accompanying diagrams, wherein:

FIG. 1 illustrates an exploded view of a laminate structure of an RFID tag, in accordance with an embodiment.

FIG. 2 illustrates an exploded view of a laminate structure of an RFID tag having a pattern printed layer on a functional adhesive, in accordance with another embodiment.

FIG. 3 illustrates an exploded view of a laminate structure of an RFID tag having a pattern printed layer on an antenna adhesive layer, in accordance with another embodiment.

FIG. 4 illustrates an exploded view of a laminate structure of an RFID tag having a pattern printed layer on an antenna adhesive layer, in accordance with another embodiment.

FIGS. 5A-5C illustrate a stepwise process for forming a pattern printed layer on an antenna adhesive layer, in accordance with the embodiments disclosed herein.

FIGS. 6A-6H illustrate various patterns on a pattern printed layer in an area proximate to a connection between the antenna leads and the strap, in accordance with the embodiments disclosed herein.

FIG. 7 illustrates a method of manufacturing an RFID tag, in accordance with an embodiment.

FIG. 8 illustrates a method of improving adhesion in an RFID tag, in accordance with an embodiment.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

The following detailed description illustrates various embodiments of the present subject matter and ways in which they can be implemented. Although some modes of carrying out the present subject matter have been disclosed, those skilled in the art would recognize that other embodiments for carrying out or practicing the present subject matter are also possible. Some embodiments disclosed herein include a radio-frequency identification (RFID) tag and a method of manufacturing the same.

Definitions:
“Antenna” refers to a device that is used to transmit and receive radio frequency signals in an RFID system.
"Strap" or "Interposer" refers to conductive leads that facilitate electrical connection between the integrated circuit and the antenna.
"Adhesive layer" refers to a layer of a substance that enables attachment of two layers or material surfaces.
"RFID tag" refers to a radio frequency identification tag that uses radio waves to identify and enable tracking of an object to which it is attached.

These and other features, aspects, embodiments, and advantages of the present subject matter will be better understood with reference to the following description and the appended claims. The foregoing definitions are provided to introduce selected concepts in simplified form and are not intended to identify key, essential, or limiting features of the claimed or disclosed subject matter, nor to limit the scope of the claims in any manner.

The present disclosure describes various embodiments of radio-frequency identification (RFID) tags and methods for their manufacture. RFID tags may be implemented as active devices, which include a power source, or as passive devices, which do not include a power source. In some embodiments, a radio-frequency identification (RFID) tag may include an antenna, a strap or interposer electrically connected to the antenna, and a pattern printed layer. The antenna comprises antenna leads, wherein conductive end portions of the antenna are electrically connected to the strap. The strap consists of an integrated circuit (IC) or microchip attached to conductive leads or pads. These conductive leads serve as a bridge between the IC and the conductive end portions of the antenna of the RFID tag. The pattern printed layer may be configured to modify adhesion characteristics in a specific area of the RFID tag. The pattern printed layer may be configured to reduce adhesive strength in an area proximate to a connection between the antenna leads and the strap. In some embodiments, the pattern printed layer may maintain overall adhesion of the RFID tag while reducing adhesive strength in the specific area. For example, the pattern printed layer may be configured to provide less adhesive strength than a strap adhesive strength.

In some embodiments, the pattern printed layer comprises a first pattern and a second pattern. The first pattern, having a first adhesive characteristic, may be printed in an area corresponding to the antenna, while the second pattern, having a second adhesive characteristic, may be printed in a bond-pad area where the strap connects to the antenna. In some embodiments, the second adhesive characteristic may differs from the first adhesive characteristic, and in some embodiments in terms of adhesion strength the second adhesive characteristic may be less than the first adhesive characteristic. Adhesion characteristics may include adhesion strength, release force, peel strength, tack and effective bonding area. In some embodiments, the adhesion characteristics may be increased, decreased, or otherwise tailored.

In one exemplary embodiment, the pattern printed layer may reduce adhesive strength in an area proximate to a bond pad area where the strap connects to the antenna leads. This reduced adhesive strength may prevent delamination of the strap from the antenna when the RFID tag is removed from a liner for application to an object, or when the inlay is transferred from one substrate to another during a manufacturing process (e.g., from a carrier to the facestock). The reduced adhesive strength in the area proximate to the bond pad where the strap connects to the antenna leads may avoid flipping of the bond pad during inlay transfer.

The RFID tag may further include a liner, with the pattern printed layer, preferably a pattern printed adhesive layer, positioned between the liner and at least one of the antenna or the strap.

The pattern printed layer may comprise a plurality of discrete adhesive areas. In some implementations, at least a portion of the pattern printed layer may be formed in various patterns, such as, for example, hexagonal patterns, dot patterns, diagonal patterns, horizontal lines, circular patterns, zigzag patterns, vertical lines, or combinations thereof, as otherwise described herein. The patterns of discrete adhesive areas may be combined to form additional types of patterns. It will be appreciated that these patterns may be selected provide the desired adhesive characteristics, and in particular adhesive strength, consistent with the embodiments disclosed herein.

In some embodiments, the pattern printed layer may be flood coated under the antenna and/or strap. In some embodiments, the pattern printed layer may be printed under the antenna and/or strap. In particular, the pattern printed layer may be flood coated in the specific area of the RFID tag corresponding to an area proximate to a connection between the antenna leads and the strap.

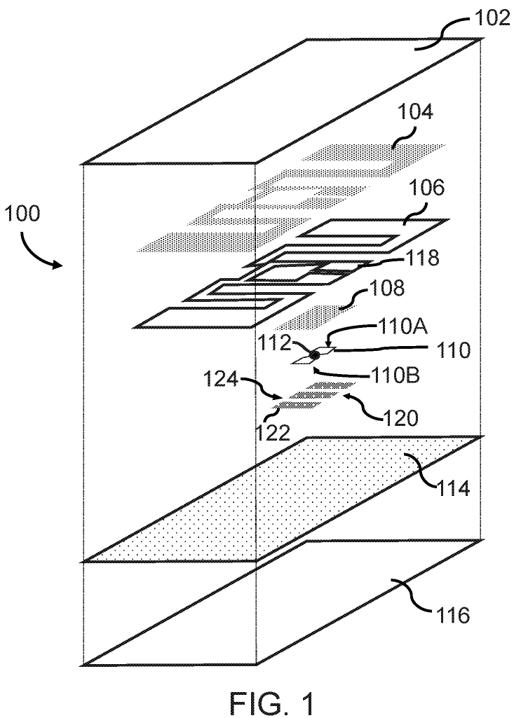

FIG. 1 is an exploded view of a laminate structure of an RFID tag 100 having a pattern printed layer positioned between the liner and the strap, in accordance with the first embodiment. The RFID tag 100 comprises a facestock layer 102, an antenna adhesive 104, an antenna 106, a strap adhesive 108, a strap 110, an RFID integrated circuit 112, a functional adhesive 114 and a liner 116. The antenna adhesive 104 may be deposited or printed in the shape of the antenna 106 or a pattern that is substantially similar to the antenna 106. The antenna 106 can be any of a variety of materials, for example, aluminum, copper, silver, conductive ink or another thin, conductive material. In some embodiments, the antenna 106 may be made from a polymer metalized with these metals, such as an aluminum/polyethylene terephthalate film. The antenna 106 may be shaped as a single dipole, dual dipoles (one perpendicular to other), a folded dipole, slot, or spiral coil. The antenna 106 comprises antenna leads 118. The antenna leads 118 are conductive end portions of the antenna 106 that electrically connect to the strap 110. The antenna 106 may be coupled to an RFID integrated circuit 112 that may be mounted to or deposited on the strap 110. The strap 110 may further include conductive leads to facilitate coupling between antenna 106 and the integrated circuit 112. In some embodiments, coupling between antenna 106 and the strap 110 may be an indirect coupling, such as a capacitive coupling.

The facestock layer 102 may be formed of a paper material, such as a cardstock paper, a bond paper or other paper type, or from flexible fabric materials including textiles, woven, nonwoven, or knitted materials. The face layer may be a monolayer or multilayer. The facestock layer 102 may have a thickness from 0.5 µm to 50 µm, e.g., from 0.5 µm to 25 µm, from 0.5 µm to 10 µm, from 0.7 µm to 5 µm, or more preferably from 1 µm to 4.5 µm. In other embodiments, the facestock may be thicker without departing from the scope of the present disclosure. The facestock layer 102 may also include a printable surface for displaying information associated with the RFID label or tag, such as product identification, branding, or tracking data.

The adhesives for the antenna adhesive 104, strap adhesive 108, or functional adhesive 114 may comprise an acrylic based formulation, an elastomeric based formulation, or combinations thereof.

The strap 110 further comprises a front side 110A, also referred to as an active side, and a back side 110B. The RFID integrated circuit 112 may be mounted on the front side 110A. The pattern printed layer 120 may be applied on the back side 110B of the strap 110. The pattern printed layer 120 may comprise an adhesive, a release agent, a varnish, or combinations thereof. As shown in FIG. 1, the pattern printed layer 120 is a pattern printed adhesive layer. The pattern printed layer 120 may be positioned between the liner 116 and the strap 110 with the functional adhesive layer 114 interposed between the pattern printed layer 120 and the liner 116. As shown in FIG. 1, the pattern printed layer 120 has a series of vertical lines that are substantially inline with the strap 110. The pattern printed layer 120 may be formed in various patterns, which may be, but are not limited to, hexagonal, dot, diagonal, horizontal line, circular, zigzag, or vertical line patterns, or combinations thereof.

The RFID integrated circuit 112 may be operatively coupled to the antenna 106 using the strap 110. The RFID integrated circuit may comprise a logic unit that makes decisions and/or memory to store data, such as tag ID, object identifier, passwords, etc. The RFID integrated circuit may be configured for use in an active RFID device or a passive RFID device. RFID integrated circuit may be fabricated from semiconductor wafers, and any suitably sized RFID integrated circuit may be used with the embodiments disclosed herein. In some embodiments, the RFID integrated circuit may be encoded with information relating to a product with which the RFID device is to be associated. Encoding may be performed before placement of the RFID integrated circuit on the antenna structure or after placement.

The pattern printed layer 120 may comprise a plurality of discrete adhesive areas 122. The spaces 124 between the plurality of discrete adhesive areas 122 have no adhesive, creating a non-uniform adhesive distribution. Preferably, the spaces may be substantially free of adhesive. In some embodiments, the non-uniform adhesive distribution may be advantageous for modifying adhesion characteristics in a specific area of the RFID tag 100. In particular the specific area that may be modified corresponds to the area of the strap 110. In some embodiments, the spaces 124 or non-adhesive regions may be configured to create controlled adhesive flow paths to control dewetting behavior. The pattern printed layer may allow air to get trapped in the non-adhesive areas, control release and improve die cutting yield.

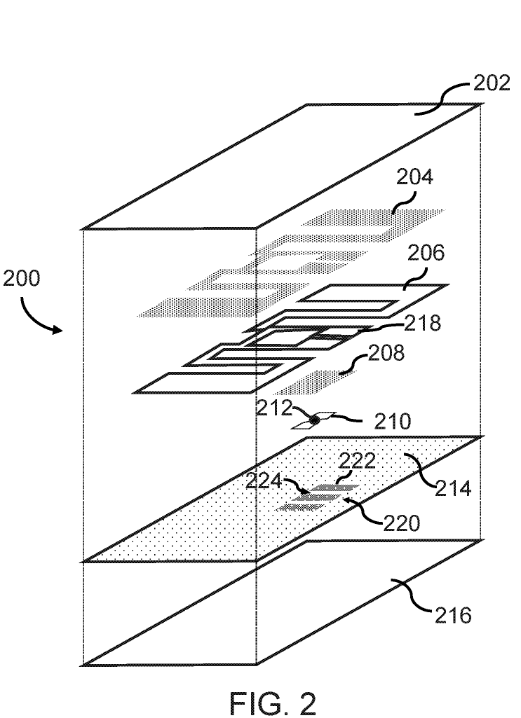

It should be understood that the arrangement of the layers shown in FIG. 1 and the other figures is merely illustrative and the layers may be rearranged or may be combined in some embodiments. As shown in FIG. 1, the pattern printed layer is a separate layer from the other adhesive layers. In one embodiment, the pattern printed layer may be integrated or formed as part of another adhesive layer. FIG. 2 illustrates an embodiment in which the pattern printed layer 220. FIG. 2 is an exploded view of a laminate structure of an RFID tag 200, in accordance with a second embodiment. The RFID tag 200 comprises a functional facestock layer 202, an antenna adhesive 204, an antenna 206, a strap adhesive 208, a strap 210, a functional adhesive 214, and a liner 216. The strap 210 may comprise RFID integrated circuit 212. The functional adhesive 214 comprises a pattern printed layer 220. In some embodiments, pattern printed layer 220 may be integrated or otherwise formed with the functional adhesive 214. In some embodiments, the pattern printed layer 220 formed on or with the functional adhesive 214 may comprise an adhesive, a release agent, a varnish, or combinations thereof. The pattern printed layer 220 may be disposed between the strap 210 and the liner 216. A portion of the pattern printed layer 220 may comprise a plurality of discrete adhesive areas 222, which may be formed in, for example, a hexagonal patterns, dot patterns, diagonal patterns, horizontal lines, circular patterns, zigzag patterns, vertical lines, or as otherwise described herein. The spaces 224 between the plurality of discrete adhesive areas 222 have no adhesive. A portion of the pattern printed layer 220 may have reduced adhesive strength in the area proximate to the connection between the antenna leads 218 and/or the strap 210. The pattern printed layer 220 may maintain overall adhesion while reducing adhesive strength in the area proximate to the connection between the antenna leads 218 and/or the strap 210.

In some embodiments, the adhesive characteristics of the pattern printed layer 220 may be different from the functional adhesive 214. The pattern printed layer 220 may be configured to provide less adhesive strength than the adhesive strength of strap adhesive 208. The reduced adhesive strength in the area proximate to the connection between the antenna leads and the strap 210 prevents delamination of the strap 210 from the antenna 206 when the RFID tag 200 is removed from the liner 216.

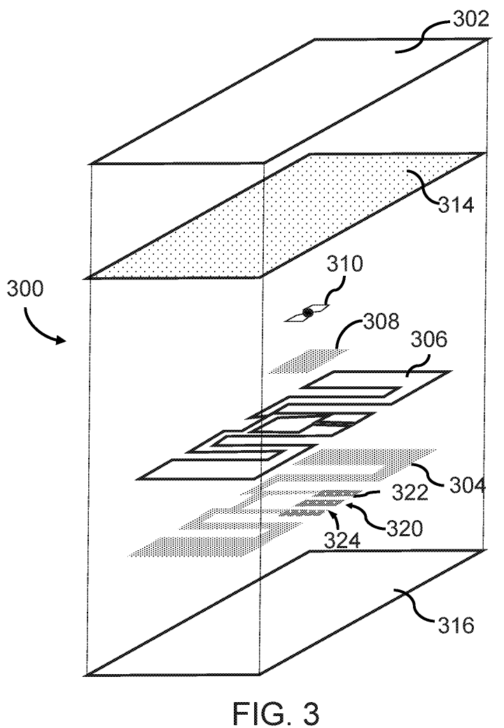

FIG. 3 is an exploded view of a laminate structure of an RFID tag 300, in accordance with a third embodiment. The RFID tag 300 may be arranged as follows a functional facestock layer 302 is positioned above the functional adhesive 314 and the strap 310 may be positioned on one side of the functional adhesive 314 opposite to the functional facestock layer 302. The strap 310 may be mounted to the antenna 306 by the strap adhesive 308. It should be understood that the RFID integrated circuit may be connected to the strap 310 as described herein. An antenna adhesive layer 304 may be positioned between the antenna 306 and a liner 316. The antenna adhesive layer 304 may be configured to have a shape that corresponds to an antenna area or corresponds to a surrounding area of the antenna 306.

In some embodiments, the antenna adhesive layer 304 may comprise a pattern printed layer 320. The pattern printed layer 320 may be formed or integrated with the antenna adhesive layer 304. In some embodiments, the pattern printed layer 320 formed on or with the functional adhesive 314 may comprise an adhesive, a release agent, a varnish, or a combination thereof. A portion of the pattern printed layer 320 may comprise a plurality of discrete adhesive areas 322, which may be formed in, for example, hexagonal patterns, dot patterns, diagonal patterns, horizontal lines, circular patterns, zigzag patterns, vertical lines or as otherwise described herein. The spaces 324 between the plurality of discrete adhesive areas 322 have no adhesive. A portion of the pattern printed layer 320 may have reduced adhesive strength as compared with the antenna adhesive layer 304 in the area proximate to the connection between the antenna leads 318 and/or the strap 310. The pattern printed layer 320 may maintain overall adhesion while reducing adhesive strength in the area proximate to the connection between the antenna leads 318 and/or the strap 310.

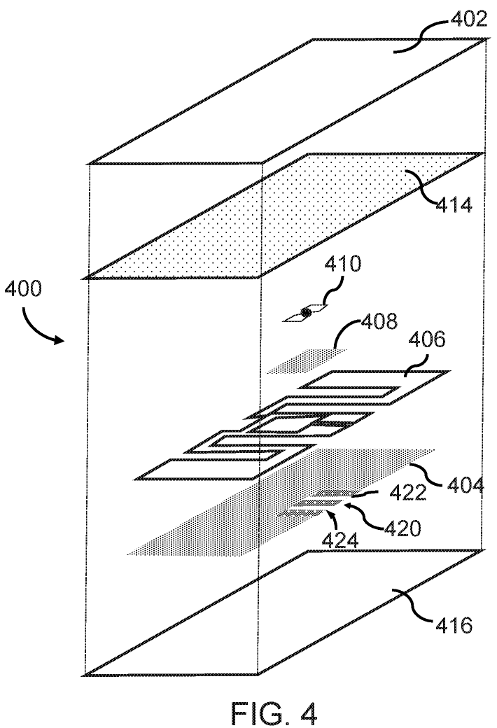

FIG. 4 is an exploded view of a laminate structure of an RFID tag 400, in accordance with a fourth embodiment. Although antenna adhesive layer 304 may have the shape of the antenna 406, in some embodiments, the antenna adhesive layer 304 may be applied to an area larger than the antenna 406. The RFID tag 400 may be arranged as follows a functional facestock layer 402 is positioned above the functional adhesive 414 and the strap 410 may be positioned on one side of the functional adhesive 414 opposite to the functional facestock layer 402. The strap 410 may be mounted to the antenna 406 by the strap adhesive 408. An antenna adhesive layer 404 may be positioned between the antenna 406 and a liner 416. The antenna adhesive layer 404 has an area that is larger than the area of the antenna 406. In some embodiments, the antenna adhesive layer 404 may be flood coated. In some embodiments, the antenna adhesive layer 406 may comprise a pattern printed layer 420, but it should be understood that the pattern printed layer 420 may be formed as a separate layer. The pattern printed layer 420 may also be formed or integrated with the antenna adhesive layer 404 as shown in FIG. 4. In some embodiments, the pattern printed layer 420 formed on or with the functional adhesive 414 may comprise an adhesive, a release agent, a varnish, or combinations thereof. A portion of the pattern printed layer 420 may comprise a plurality of discrete adhesive areas 422, which may be formed in, for example, hexagonal patterns, dot patterns, diagonal patterns, horizontal lines, circular patterns, zigzag patterns, vertical lines or as otherwise described herein. The spaces 424 between the plurality of discrete adhesive areas 422 have no adhesive. A portion of the pattern printed layer 420 may have reduced adhesive strength as compared with the antenna adhesive layer 406 in the area proximate to the connection between the antenna leads 418 and/or the strap 410. The pattern printed layer 420 may maintain overall adhesion while reducing adhesive strength in the area proximate to the connection between the antenna leads 418 and/or the strap 410.

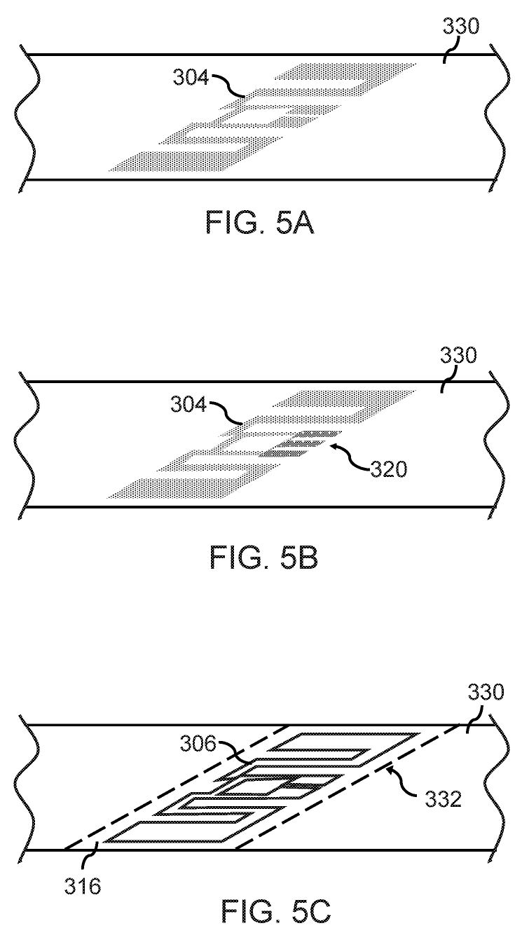

FIGS. 5A-5C illustrate a stepwise schematic flow of manufacturing of the antenna 306 on the antenna adhesive layer 304. It should be understood that the stepwise schematic flow of manufacturing may be applied to the other embodiments disclosed herein. In FIG. 5A, at a first step, the antenna adhesive layer 304 may be printed or applied in a shape or pattern of the antenna on a base substrate 330. The base substrate 330 is selected from a group comprising, but not limited to, a polyethylene terephthalate (PET), paper substrates, polyester films, polypropylene (PP) films, polyethylene (PE), and textile or fabric material. Next in a second step shown in FIG. 5B, a pattern printed layer 320 may be printed or applied to the antenna adhesive layer 304. In some embodiments, the first and second steps may be done separately, or may be done together. In some embodiments, the antenna adhesive layer 304 may be applied in a single manufacturing step that incorporates both the first and second patterns. For instance, a printing process such as flexography may be utilized to deposit an adhesive pattern encompassing both the first pattern, which corresponds to the antenna shape, and the second pattern in the bond area where the strap connects to the antenna.

As shown in FIG. 5B, there are two different patterns. A first pattern, namely the antenna adhesive layer 304, with a first adhesive strength is applied on an area corresponding to the shape or pattern of the antenna. A second pattern, namely the pattern printed layer 320, with a second adhesive strength is applied in a bond area where the strap may be connected to the antenna. In some embodiments, the area of the second pattern may be less than the area of the first pattern. After both patterns are applied, an antenna 306 may be disposed on top of the adhesive layer 304 and pattern printed layer 320 as shown in FIG. 5C. A conductive material may be applied over the antenna adhesive layer 304. The conductive material may include, but is not limited to, metallic foils, conductive inks, or other electrically conductive substances. The metallic foil may be laminated over the antenna adhesive layer 304, and the antenna pattern may be cut using at least one of, but not limited to, a die cutting, a laser cutting, a hybrid cutting method, or any other suitable method. In some embodiments, the pattern printed layer 320 may facilitate waste removal during die cutting. In some embodiments, the base substrate 330 may be cut along dashed lines 332 and used as the liner 316. In other embodiments, a separate liner may be added to the construction.

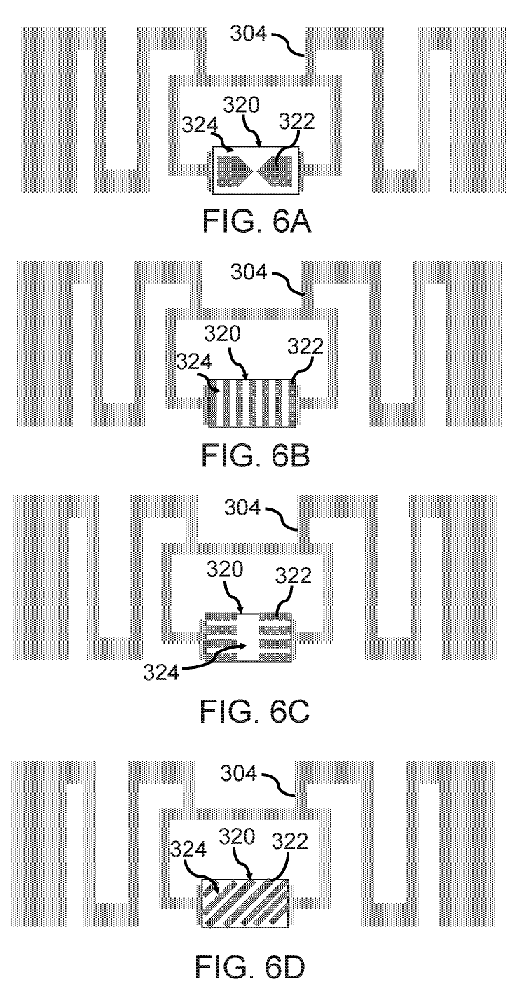

FIG. 6A-6H illustrates various patterns that may be used for the second pattern, or the pattern printed layer 320, in the bond pad area where the strap connects to the antenna. For purposes of illustration, the construction shown in FIG. 3 is referenced, with the pattern printed layer 320 formed on the antenna adhesive layer 304. Each of the pattern printed layer 320 has discrete areas 322 of adhesive and spaces 324 having no adhesive, where the spaces 324 separating the discrete areas 322. In some embodiments, the pattern printed layer 320 may be used to control dewetting behavior and adhesive release characteristics. A variety of patterns may be used for the pattern printed layer 320, which may be included by is not limited to a pattern in the shape of the strap (FIG. 6A), vertical lines (FIG. 6B), segmented horizontal lines (FIG. 6C), diagonal lines (FIG. 6D), dot patterns (FIG. 6E), circular patterns (FIG. 6F), zig-zag patterns (FIG. 6G) or a pattern comprised of geometrical shapes such as hexagons (FIG. 6H). In general, the adhesive of the pattern printed layer 320 is formed to provide the space 324 thereby reducing or eliminating the interconnection between adjacent discrete areas 322. Although these patterns are illustrative, additional patterns may be used in some embodiments without departing from the present disclosure. In addition, various combinations of patterns may be used without limitations according to the embodiments described herein.

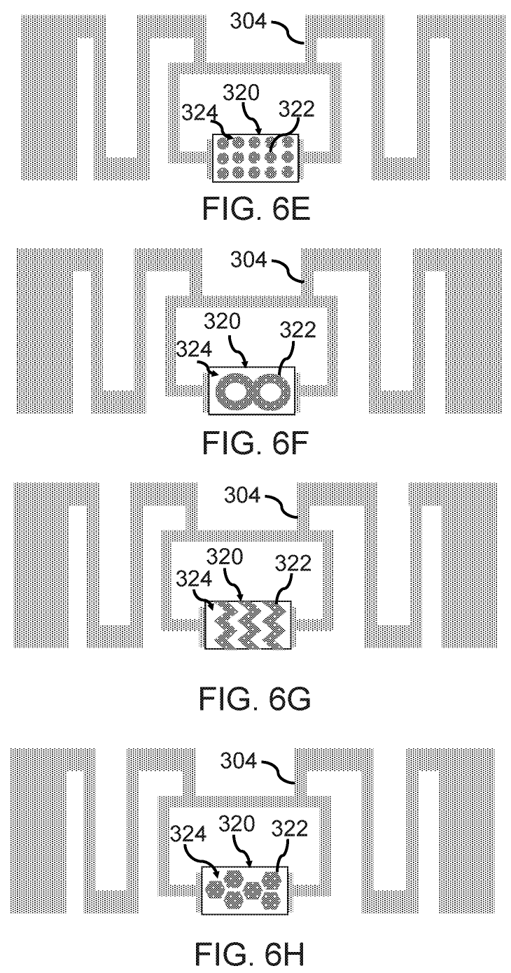

FIG. 7 is a method 700 of manufacturing an RFID tag in accordance with an embodiment. At step 702, the antenna may be electrically connected to the strap. This electrical connection may be achieved through various methods known in the art or disclosed herein. For example, the electrical connection may be formed by direct physical contact between conductive elements of the antenna and the strap, or through capacitive coupling. In some embodiments, the electrical connection may be established using conductive adhesives, soldering, welding, or mechanical pressure.

At step 704, the pattern printed layer may be applied between the liner and at least one of the antenna and/or the strap. By applying the pattern printed layer in such a manner with at least one of the antenna or the strap, the pattern printed layer may be configured to modify adhesion characteristics in a specific area of the RFID tag.

In some embodiments, step 704 includes applying a pattern printed layer may comprise a step for applying a first pattern with a first adhesive characteristic in an area corresponding to the antenna, and a step applying a second pattern with a second adhesive characteristic in the bond pad area where the strap connects to the antenna, with the second adhesive characteristic being different than the first adhesive characteristic. For example, the adhesive characteristic may be adhesive strength, and the second adhesive strength may be less than the first adhesive strength.

In some embodiments, step 704 includes applying a pattern printed layer may involve a step for flood coating an adhesive layer and then selectively pattern printing the adhesive layer in an area proximate to a connection between the antenna and the strap to reduce adhesive strength in the area.

The method may include steps for arranging the antenna, strap, and liner in different configurations. In one embodiment, the strap may be positioned between the antenna and the liner with the pattern printed layer between the strap and the liner.

In another embodiment, the antenna may be positioned between the strap and the liner with the pattern printed layer between the antenna and the liner.

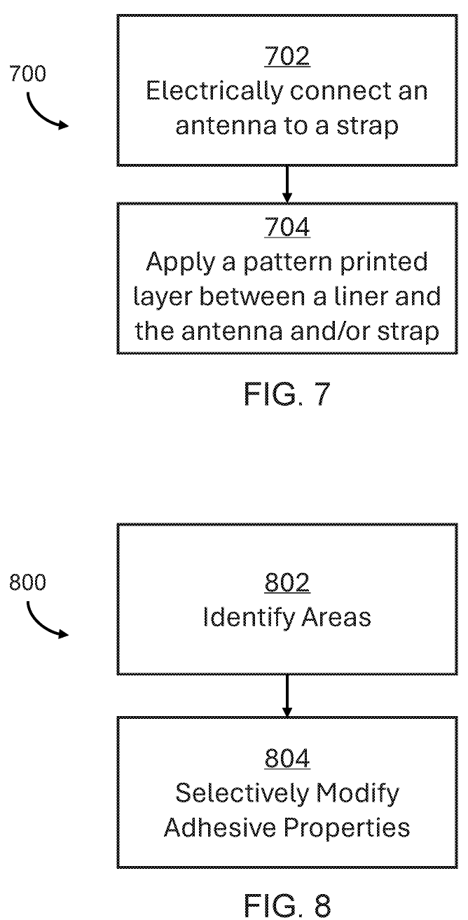

FIG. 8 is a method 800 of improving adhesion in an RFID tag in accordance with an embodiment.

At step 802, areas proximate to a connection between the antenna leads and/or a strap of the RFID tag requiring different adhesion characteristics, are identified. This may include identifying an antenna area and a bond pad area where the strap connects to the antenna.

At step 804, adhesive properties in the identified areas may be selectively modified by printing or disposing a pattern printed layer. In some aspects, the method may comprise selectively modifying adhesive properties may involve applying the first pattern with the first adhesive characteristic in the identified antenna area and applying the second pattern with the second adhesive characteristic in the identified bond pad area, where the second adhesive characteristic is different from the first adhesive characteristic.

In some embodiments, the method may include flood coating an adhesive layer and pattern printing an adhesive, a release agent, a varnish, or a combination thereof in the area proximate to the connection between the antenna leads and the strap to reduce adhesive strength at the interface of the strap and antenna.

In some aspects, an RFID tag laminate structure is disclosed in accordance with an embodiment. The RFID tag laminate may comprise an antenna, a strap electrically connected to the antenna, a pattern printed layer, and a facestock layer disposed over the antenna and the strap. The pattern printed layer may be disposed between a liner and the antenna, or between the liner and the strap. In some embodiments, the strap may be positioned between the antenna and the liner, with the pattern printed layer between the strap and the liner. In some embodiments, the antenna may be positioned between the strap and the liner, with the pattern printed layer between the antenna and the liner. The pattern printed layer may be configured to prevent delamination of the strap from the antenna while allowing removal of the facestock layer, antenna, and strap as a unit from the liner.

In some aspects, the RFID tag and manufacturing method described herein may offer several advantages. The pattern printed layer may allow for precise control of adhesion characteristics in specific areas of the RFID tag. This targeted approach to adhesive application may help improve the overall performance and reliability of the tag. By reducing adhesive strength in areas proximate to the connection between antenna leads and the strap, the risk of delamination during tag removal and application may be decreased. This may result in improved durability and longevity of the RFID tags in various applications.

The ability to maintain overall adhesion while selectively modifying adhesive properties in specific areas may provide a balance between secure attachment and ease of handling. This may enhance the tag's usability across different environments and conditions.

The pattern printed layer may allow for customization of adhesive patterns and strengths to suit different antenna designs, strap configurations, and application requirements. This flexibility may enable the production of RFID tags tailored to specific use cases.

The manufacturing methods described, such as pattern printing or flood coating with selective pattern printing, may offer efficient and cost-effective ways to produce RFID tags with improved adhesive properties. This may potentially lead to reduced production costs and improved manufacturing yields.

The ability to prevent delamination of the strap from the antenna while allowing removal of the facestock layer, antenna, and strap as a unit from the liner may simplify the application process and improve the overall user experience.

By addressing common issues like the "sticky strap" problem and "bond pad flipping," the described RFID tag design and methods for manufacturing the RFID tags may offer improved reliability and performance compared to conventional designs and/or methods.

The method may allow for the use of thinner adhesive layers in specific areas of the RFID tag, potentially improving the RF performance of the tag without compromising its structural integrity. In one embodiment, the pattern printed layer may have a thickness of less than or equal to 10 microns, e.g., less than or equal to 5 microns, less than or equal to 4 microns, less than or equal to 3 microns, or less than or equal to 2.5 microns.

In all these embodiments, the pattern printed layer may be configured to modify adhesion characteristics in specific areas of the RFID tag, particularly in areas proximate to the connection between the antenna leads and the strap. This modification of adhesion characteristics may help prevent issues such as delamination of the strap from the antenna while maintaining overall adhesion of the RFID tag.

In some embodiments, the pattern printed layer may be configured to reduce, but not eliminate, the adhesive strength in the area proximate to the bond pad where the strap connects to the antenna leads. This approach of decreasing adhesive strength, rather than completely eliminating adhesive in this area, may help to prevent the formation of bubbles during the manufacturing process. The presence of a reduced amount of adhesive in the bond pad area may maintain a level of adhesion that is sufficient to ensure proper contact between layers and minimize air entrapment.

In some embodiments, the adhesive strength under the bond pad may be maintained above a minimum threshold required to avoid bubbles or other manufacturing issues. This minimum threshold may vary depending on factors such as the specific materials used, the manufacturing process employed, and the environmental conditions during production.

Modifications to embodiments of the present subject matter described in the foregoing are possible without departing from the scope of the present subject matter as defined by the accompanying claims. Expressions such as “including”, “comprising”, “incorporating”, “have”, “is” used to describe and claim the present subject matter are intended to be construed in a non-exclusive manner, namely allowing for items, components or elements not explicitly described also to be present. Reference to the singular is also to be construed to relate to the plural.

What is claimed is:

1. A radio-frequency identification (RFID) tag comprising:
an antenna;
a strap electrically connected to the antenna; and
a pattern printed layer,
wherein the pattern printed layer is configured to modify adhesion characteristics in a specific area of the RFID tag.

2. The RFID tag of claim 1, wherein the antenna comprises antenna leads, wherein the antenna leads are conductive end portions of the antenna that electrically connect to the strap.

3. The RFID tag of claim 2, wherein the pattern printed layer is configured to reduce adhesive strength in an area proximate to a connection between the antenna leads and the strap.

4. The RFID tag of claim 3, wherein the reduced adhesive strength in the area proximate to the connection between the antenna leads and the strap prevents delamination of the strap from the antenna when the RFID tag is removed from a liner.

5. The RFID tag of claim 1, wherein the pattern printed layer maintains overall adhesion of the RFID tag while reducing adhesive strength in the specific area.

6. The RFID tag of claim 1, further comprising a liner, wherein the pattern printed layer is positioned between the liner and at least one of the antenna, or the strap.

7. The RFID tag of claim 1, wherein the pattern printed layer comprises a plurality of discrete adhesive areas.

8. The RFID tag of claim 1, wherein at least a portion of pattern printed layer is formed in hexagonal patterns, dot patterns, diagonal patterns, horizontal lines, circular patterns, zigzag patterns and vertical lines.

9. The RFID tag of claim 1, wherein the pattern printed layer is configured to provide less adhesive strength than a strap adhesive strength.

10. A method of manufacturing a radio-frequency identification (RFID) tag, the method comprising:
electrically connecting an antenna to a strap;
applying a pattern printed layer between a liner and at least one of: (a) the antenna, or (b) the strap; and
wherein the pattern printed layer is configured to modify adhesion characteristics in a specific area of the RFID tag.

11. The method of claim 10, wherein applying the pattern printed layer comprises:
applying a first pattern with a first adhesive strength in an area corresponding to the antenna; and
applying a second pattern with a second adhesive strength in a bond pad area where the strap connects to the antenna, wherein the second adhesive strength is less than the first adhesive strength.

12. The method of claim 10, wherein applying the pattern printed layer comprises:
a. flood coating an adhesive layer; andb. selectively pattern printing the adhesive layer in an area proximate to a connection between the antenna and the strap to reduce adhesive strength in the area.

13. The method of claim 10, wherein applying the pattern printed layer comprises maintaining overall adhesion of the RFID tag while reducing adhesive strength in the specific area.

14. The method of claim 10, further comprising arranging the antenna, strap, and liner in one of the following configurations:
c. positioning the strap between the antenna and the liner with the pattern printed layer between the strap and the liner, ord. positioning the antenna between the strap and the liner with the pattern printed layer between the antenna and the liner.

15. The method of claim 10, wherein the pattern printed layer comprises a plurality of discrete adhesive areas.

16. The method of claim 10, further comprising forming at least a portion of pattern printed layer in hexagonal patterns, dot patterns, diagonal patterns, horizontal lines, circular patterns, zigzag patterns and vertical lines.

17. A method of improving adhesion in a radio-frequency identification (RFID) tag, the method comprising:
identifying areas proximate to a connection between antenna leads and a strap of the RFID tag requiring different adhesion characteristics; and
selectively modifying adhesive properties in the identified areas by pattern printing an adhesive layer.

18. The method of claim 17, wherein identifying areas proximate to a connection between the antenna leads and the strap comprises:
identifying an antenna area; and
identifying a bond pad area where the strap connects to the antenna.

19. The method of claim 17, wherein selectively modifying adhesive properties comprises:
applying a first pattern with a first adhesive strength in the identified antenna area; and
applying a second pattern with a second adhesive strength in the identified bond pad area, wherein the second adhesive strength is less than the first adhesive strength.

20. The method of claim 17, wherein selectively modifying adhesive properties comprises:
flood coating an adhesive layer; and
pattern printing an adhesive, a release agent or a varnish in the area proximate to the connection between the antenna leads and the strap to reduce adhesive strength at the interface of the strap and antenna.

21. A radio-frequency identification (RFID) tag laminate structure comprising:
an antenna;
a strap electrically connected to the antenna;
a pattern printed layer; and
a facestock layer disposed over the antenna and the strap,
wherein the pattern printed layer is configured to modify adhesion characteristics in a specific area of the RFID tag laminate structure.

22. The RFID tag laminate structure of claim 21, wherein the pattern printed layer is disposed between a liner and the antenna.

23. The RFID tag laminate structure of claim 21, wherein the pattern printed layer is disposed between the liner and the strap.

24. The RFID tag laminate structure of claim 21, wherein at least a portion of pattern printed layer is formed in hexagonal patterns, dot patterns, diagonal patterns, horizontal lines, circular patterns, zigzag patterns and vertical lines.

25. The RFID tag laminate structure of claim 21, wherein the antenna comprises antenna leads, and the pattern printed layer is configured to reduce adhesive strength in an area proximate to a connection between the antenna leads and the strap.

26. The RFID tag laminate structure of claim 21, wherein the strap is positioned between the antenna and the liner, with the pattern printed layer between the strap and the liner.

27. The RFID tag laminate structure of claim 21, wherein the antenna is positioned between the strap and the liner, with the pattern printed layer between the antenna and the liner.

28. The RFID tag laminate structure of claim 27, wherein the pattern printed layer is flood coated and/or pattern printed under the antenna.

29. The RFID tag laminate structure of claim 21, wherein the pattern printed layer is configured to prevent delamination of the strap from the antenna while allowing removal of the facestock layer, antenna, and strap as a unit from the liner.

30. The RFID tag laminate structure of claim 21, wherein the pattern printed layer is a pattern printed adhesive layer.
